(19) United States
(12) Patent Application Publication
(10) Pub. No.: US 2015/0281343 A1
(43) Pub. Date: Oct. 1, 2015

(54) INFORMATION PROCESSING DEVICE, INFORMATION PROCESSING SYSTEM, AND PROCESSING METHOD

(71) Applicant: FUJITSU LIMITED, Kawasaki-shi (JP)

(72) Inventors: Daisuke Yamashita, Kawasaki (JP); Masahide Noda, Kawasaki (JP); Junichi Yura, Kawasaki (JP); Hideto Kihara, Kawasaki (JP); Takashi Ohno, Kobe (JP); Norihiko Igarashi, Kawasaki (JP); Jun Hanagata, Meguro (JP)

(73) Assignee: Fujitsu Limited, Kawasaki-shi (JP)

(21) Appl. No.: 14/668,257

(22) Filed: Mar. 25, 2015

(30) Foreign Application Priority Data
Mar. 31, 2014 (JP) 2014-074567

(51) Int. Cl. H04L 29/08; H04L 29/06

(52) U.S. Cl. CPC H04L 67/1002; H04L 67/02; H04L 67/42

(57) ABSTRACT

An information processing device includes a computer processor; and a memory which stores a plurality of instructions, which when executed by the computer processor, cause the computer processor to execute: obtaining a decrypted Web application from a Web server in a native area, and executing the decrypted Web application, giving a notification of obtaining the Web application to the computer processor based on the decryption of the Web application; and obtaining the decrypted Web application from the Web server based on the notification.

### CROSS-REFERENCE TO RELATED APPLICATION

This application is based upon and claims the benefit of priority of the prior Japanese Patent Application No. 2014-074567, filed on Mar. 31, 2014, the entire contents of which are incorporated herein by reference.

### FIELD

The embodiments discussed herein are related to an information processing device, an information processing system, a program, and a processing method, for example.

### BACKGROUND

In recent years, in an information processing device, such as a personal computer (PC), a tablet terminal device, a smart phone, and the like, it is expected to use Web applications, because reductions in development man-hour is possible. Web applications are executed in a Web area on a browser, and thus have lower machine dependency compared with native applications that are executed in a native area on an operating system (OS). Also, restrictions are given to processing that is allowed to be executed in a Web area, and thus the Web applications are highly secured. However, in the case of using only Web applications, processing is restricted, and thereby it is not possible to fully utilize the functions of an information processing device unlike native applications. Accordingly, a hybrid type is provided in which a local Web server is started in a native area, and the local Web server decrypts and provides a Web application. The documents disclosing such a technique include, for example, Japanese National Publication of International Patent Application No. 2004-537101, and Japanese Laid-open Patent Publication Nos. 2006-323614 and 2011-107745.

### SUMMARY

In accordance with an aspect of the embodiments, an information processing device includes a computer processor; and a memory which stores a plurality of instructions, which when executed by the computer processor, cause the computer processor to execute: obtaining a decrypted Web application from a Web server in a native area, and executing the decrypted Web application, giving a notification of obtaining the Web application to the computer processor based on the decryption of the Web application; and obtaining the decrypted Web application from the Web server based on the notification.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is an explanatory diagram exemplifying an execution environment of a Web application of an information processing device according to an embodiment;

FIG. 2 is a block diagram exemplifying a functional configuration of an information processing device according to the embodiment;

FIG. 3 is a sequence diagram exemplifying operation of an information processing device according to the embodiment;

FIG. 4 is a block diagram exemplifying a functional configuration of an information processing device according to a variation 1;

FIG. 5 is a sequence diagram exemplifying operation of an information processing device according to the variation 1;

FIG. 6 is a block diagram exemplifying a functional configuration of an information processing device according to a variation 2;

FIG. 7 is a sequence diagram exemplifying operation of the information processing device according to the variation 2; and

FIG. 8 is a block diagram exemplifying a hardware configuration of an information processing device, and a server appliance according to the embodiment.

### DESCRIPTION OF EMBODIMENTS

In the following, a description will be given of an information processing device, an information processing system, a program, and a processing method according to an embodiment with reference to the drawings. In the embodiment, the same symbol is given to a component having the same functions in a configuration, and a duplicated description will be omitted. In this regard, an information processing device, an information processing system, a program, and a processing method that are described in the following embodiments are only examples, and do not limit the embodiments. Also, each of the following embodiments may be suitably combined within a range not conflicting with each other.

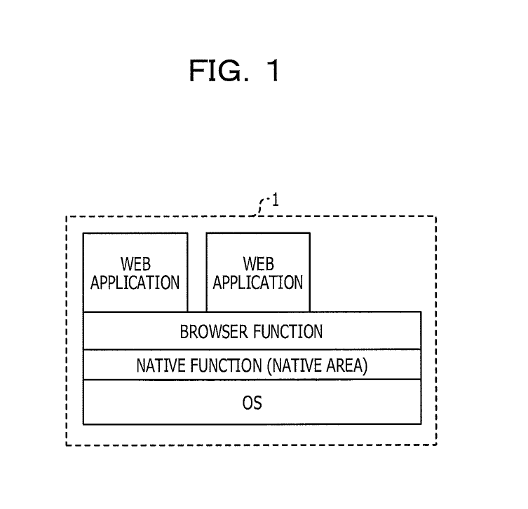

FIG. 1 is an explanatory diagram exemplifying an execution environment of a Web application of an information processing device 1 according to an embodiment. As illustrated in FIG. 1, the information processing device 1 is a PC, a tablet terminal device, a smart phone, or the like that executes application software (an application) in an execution environment on an OS. In the information processing device 1, a central processing unit (CPU) executes a basic program, such as an OS, and the like so as to provide applications with an execution environment for using hardware (a detailed description will be given of a hardware configuration later).

The Web application in this execution environment is configured to be executed on a browser function, and is a hybrid type capable of using hardware through a native function (native area). Specifically, some of the Web applications are provided by a local Web server (a HTTP server, hereinafter, referred to as a local server) in a native area. Thereby, it is possible for the Web application to fully derive the functions of the information processing device 1 through the local server.

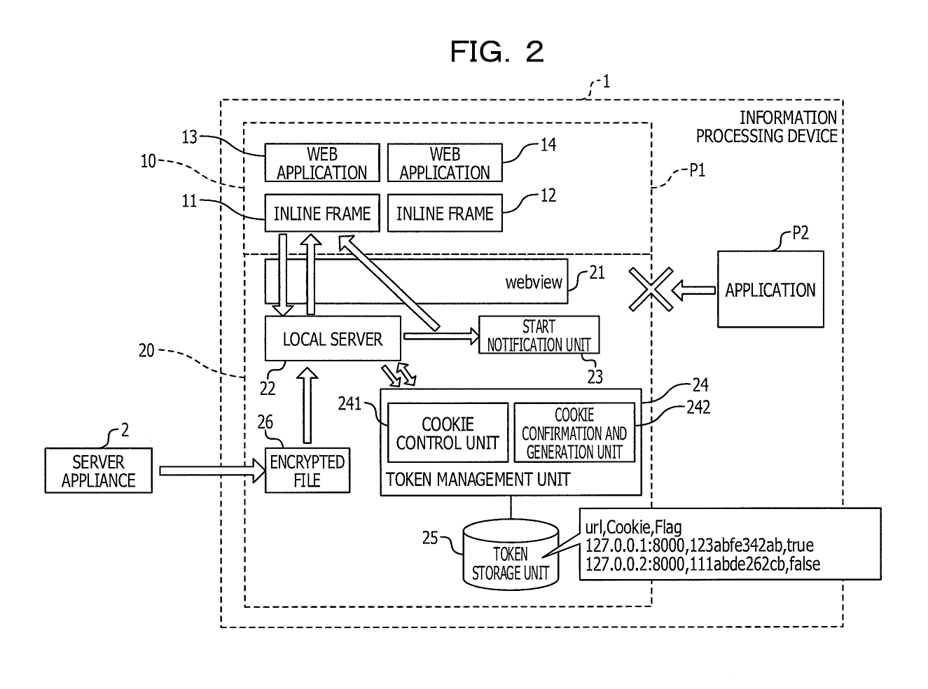

FIG. 2 is a block diagram exemplifying a functional configuration of the information processing device 1 according to the embodiment. In FIG. 2, a process P1 illustrates a process related to execution of the above-described hybrid Web applications 13 and 14, and a process P2 illustrates a process related to execution of the other applications.

A server appliance 2 provides various services to the information processing device 1 connected through a communication network (not illustrated in FIG. 2), such as the Internet, or the like. Specifically, the server appliance 2 provides an encrypted file 26 related to the Web applications 13 and 14, and the like to the information processing device 1. The encrypted file 26 is an encrypted file of the data related to the Web applications 13, 14, and the like in a secure file system (SFS), and is stored in a storage, or the like.

The process P1 has a configuration including a browser execution unit 10, which is a browser on a Webview 21, and a native function unit 20. The communications of each unit in the process P1 are performed through a predetermined application programming interface (API). The browser execution unit 10 executes the Web applications 13 and 14 in an inline frame 11 and an inline frame 12, respectively. The native function unit 20 includes the Webview 21, a local server 22, a start notification unit 23, a token management unit 24, and a token storage unit 25.

The Webview 21 provides a simple browser function. The local server 22 is a local Web server (http server) in the native function unit 20. The local server 22 responds to a request by the specification of a local uniform resource locator (URL) having an IP address of “127.0.0.1”, and a communication port of “8000”, or the like. For example, the local server 22 loads a Web application produced by decrypting the encrypted file 26 to the memory, and outputs the decrypted Web application in response to a request by the URL.

The start notification unit 23 notifies the start (startup) of the local server 22 to the browser execution unit 10 based on the notification from the local server 22. The browser execution unit 10 creates an inline frame (the inline frame 11 illustrated in FIG. 2) based on the notification from the start notification unit 23, and executes the Web application (the Web application 13 illustrated in FIG. 2) obtained by the request to the local server 22.

The token management unit 24 manages token information related to communication between the browser execution unit 10 and the local server 22. The token information is identification information intended for identification of communication, management of a session, and the like, and is assumed to be an HTTP cookie (hereinafter, referred to as a cookie) in the present embodiment. The token management unit 24 includes a cookie control unit 241 that controls a cookie, and a cookie confirmation and generation unit 242 that confirms and generates a cookie (a detailed description will be given later).

The token storage unit 25 stores token information managed by the token management unit 24. Specifically, the token storage unit 25 stores a URL (url), a cookie, and a flag (Flag) as token information. The url is an address with which the local server 22 gives a response of a decrypted Web application. The cookie is a value transmitted at a time when a Web application is given as a response. The Flag indicates whether a Web application with a cookie has been given as a response (true) or not (false) to a request specifying a url.

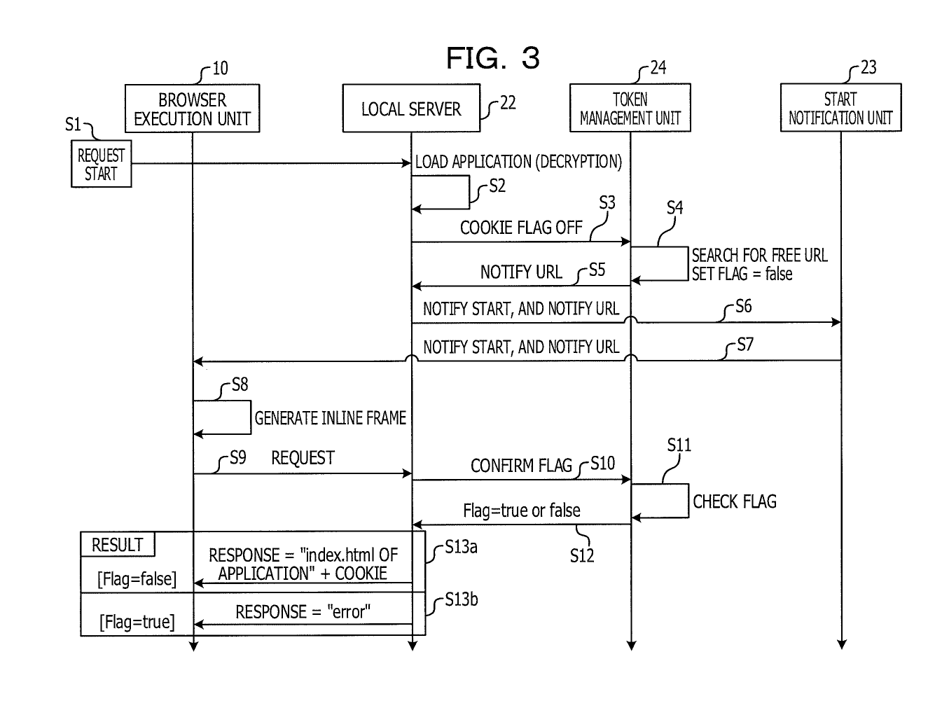

Here, a detailed description will be given of operation of the information processing device 1 at the time of starting a Web application. FIG. 3 is a sequence diagram exemplifying operation of the information processing device 1 according to the embodiment.

As illustrated in FIG. 3, the information processing device 1 starts the process P1 upon receiving (S1) a start request (for example, an execution request of an application from a console) of a Web application. The local server 22 loads (S2) the Web application (the Web application 13 in the example in FIG. 1) to the memory in response to the start request of the Web application. Specifically, the local server 22 loads the Web application 13 produced by decrypting the encrypted file 26.

Next, the local server 22 makes a request to the token management unit 24 to generate a cookie having the flag off (Flag=false) (S3). The cookie confirmation and generation unit 242 of the token management unit 24 receives the request from the local server 22, and generates a cookie (S4). Specifically, the cookie confirmation and generation unit 242 refers to information stored by the token storage unit 25, and searches for an unused free url. Next, the cookie confirmation and generation unit 242 generates a cookie of the searched free url, sets Flag=false, and sets the url, the cookie, and the Flag value in the token storage unit 25.

Next, the cookie control unit 241 of the token management unit 24 notifies the free url for which the cookie is generated to the local server 22 (S5). The local server 22 that has received the notification of the free url sends a start notification for starting the browser, and a notification of the free url that publishes the decrypted Web application 13 to the start notification unit 23 (S6). The start notification unit 23 that has received the start notification and the url from the local server 22 notifies the start notification and the url to the browser execution unit 10 to start the browser (S7).

The browser execution unit 10 that has received the start notification and the url creates an inline frame (the inline frame 11 in the example in FIG. 1) (S8), and requests the notified url from the local server 22 (S9). In the process P1, a time interval between the start notification from the start notification unit 23 and the issue of a request from the browser execution unit 10 to the local server 22 is a short time, which is about a few milliseconds. Accordingly, the browser execution unit 10 is allowed to promptly make a request, and to obtain the Web application after the decrypted Web application becomes available from the local server 22. Accordingly, it is possible for the browser execution unit 10 to obtain the Web application before an unpredictable request is sent by the process P2, or the like.

The local server 22 that has received the request of the url from the browser execution unit 10 makes a request to the token management unit 24 for confirming the Flag of the url (S10). The cookie confirmation and generation unit 242 of the token management unit 24 that has received the request of the Flag confirmation of the url checks the Flag of the url stored in the token storage unit 25 (S11), and returns a check flag (true or false) (S12).

Specifically, if the Flag of the url is false, the cookie confirmation and generation unit 242 returns false. Then, the Web application with the cookie is returned to the request, and thus the cookie confirmation and generation unit 242 sets the Flag of the url stored in the token storage unit 25 to true. Also, if the Flag of the url is true, the Web application with the cookie has been returned once, the cookie confirmation and generation unit 242 returns true, and keeps the setting of the token storage unit 25 without change.

The local server 22 makes a response to the browser execution unit 10 based on the check result from the token management unit 24 (S13a, S13b). Specifically, if the check flag is false, the local server 22 returns the url (for example, “index.html”) of the Web application (the Web application 13 in the example in FIG. 1) with the cookie (S13a). Thereby, the browser execution unit 10 executes the Web application in the created inline frame, and is allowed to perform communication with the local server 22 after that securely through authentication by the cookie.

Also, if the check flag is true, the local server 22 has returned the Web application with a cookie once, and thus the local server 22 returns an error (S13b). Accordingly, if the Web application has been returned once after the start notification, an error is returned to the subsequent request. Accordingly, obtaining the Web application by an unpredictable request from the process P2, or the like is avoided.

Also, after the token management unit 24 generated a cookie with the flag off (Flag=false), and then at a time when a predetermined time period (for example, about a few milliseconds) elapsed, the token management unit 24 may set the flag on (Flag=true). Specifically, after the cookie control unit 241 of the token management unit 24 sets the url, the cookie, and the Flag in the token storage unit 25 based on the value measured by a real time clock (RTC), or the like, and then at a time when a predetermined time period elapsed, the cookie control unit 241 of the token management unit 24 sets the value of the Flag to true.

Thereby, if the local server 22 receives a request from the browser execution unit 10 within a predetermined time period after the start notification unit 23 sent a start notification to the browser execution unit 10, the local server 22 makes a response with the Flag=false. That is to say, the local server 22 outputs the Web application in response to the request from the browser execution unit 10. In this manner, the local server 22 restricts time when the Web application is allowed to be obtained so that obtaining the Web application by an unpredictable request from the process P2, or the like is avoided.

Variation 1

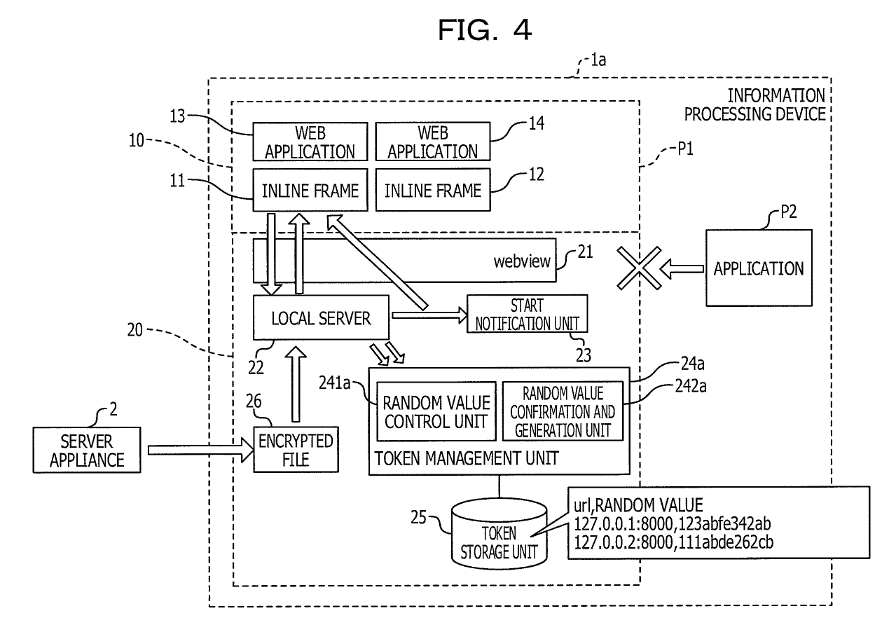

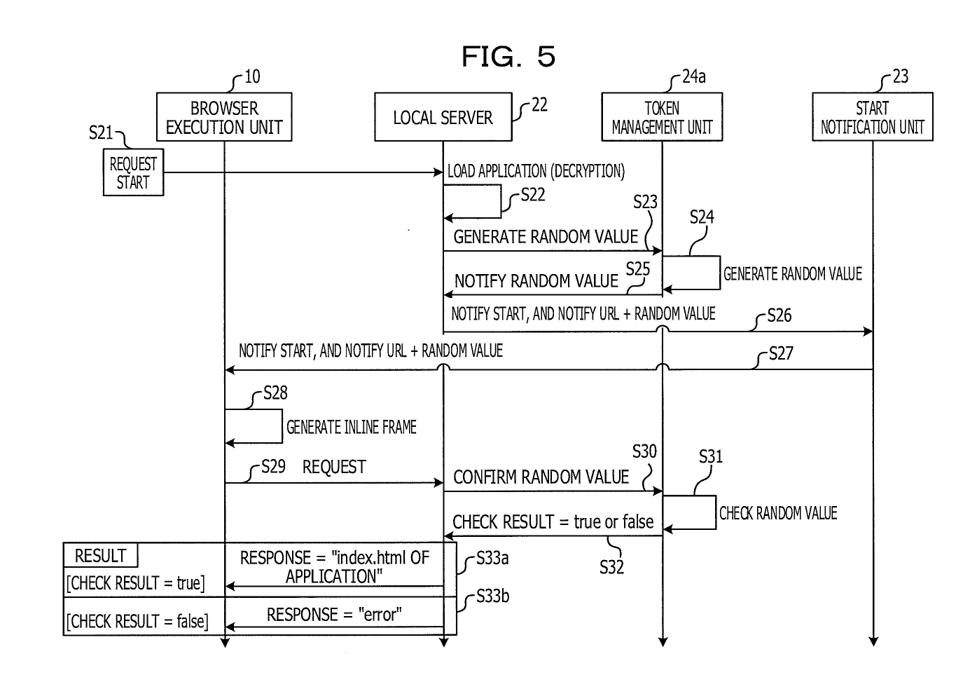

Next, a description will be given of the case of using a random value generated randomly as token information related to the communication with the local server 22 as a variation 1 of the above-described embodiment. FIG. 4 is a block diagram exemplifying a functional configuration of an information processing device is according to a variation 1. FIG. 5 is a sequence diagram exemplifying operation of the information processing device is according to the variation 1.

As illustrated in FIG. 4, the information processing device is has a configuration including a token management unit 24a that manages a random value generated randomly as token information. The token management unit 24a includes a random value control unit 241a that controls a random value, and a random value confirmation and generation unit 242a that confirms and generates a random value.

As illustrated in FIG. 5, the information processing device is starts a process P1 upon receiving a start request of the Web application (S21). In response to the start request of the Web application, the local server 22 loads the Web application (the Web application 13 in the example in FIG. 4) into the memory (S22). Specifically, the local server 22 loads the Web application 13 produced by decrypting an encrypted file 26 into the memory.

Next, the local server 22 requests the token management unit 24a to generate a random value (S23). Upon receiving the request from the local server 22, the random value confirmation and generation unit 242a of the token management unit 24a generates a random value produced in combination of alphanumeric values, and the like. (S24). Specifically, the random value confirmation and generation unit 242a refers to the information stored in the token storage unit 25, and searches for an unused free url. Next, the random value confirmation and generation unit 242a generates a random value in the searched free url, and sets the url and the random value in the token storage unit 25.

Next, the random value control unit 241a of the token management unit 24 notifies the random value and the url to the local server 22 (S25). The local server 22 that has received the random value and the url sends a start notification for starting the browser, and a notification of url+random value for publishing the decrypted Web application 13 to the start notification unit 23 (S26). The start notification unit 23 that has received the start notification and the notification of url+random value from the local server 22 sends a start notification and the notification of url+random value to the browser execution unit 10 in order to start the browser (S27).

The browser execution unit 10 that has received the start notification and the url+random value creates an inline frame (the inline frame 11 in the example in FIG. 4) (S28), and makes a request for the notified url+random value to the local server 22 (S29).

The local server 22 that has received the request for the url+random value from the browser execution unit 10 makes a request for confirmation of the random value to the token management unit 24a (S30). The random value confirmation and generation unit 242a of the token management unit 24a that has been requested for the confirmation of the random value checks the random value of the url stored in the token storage unit 25 (S31), and returns a check result (true or false) (S32).

Specifically, if the random value that has been requested for confirmation matches the random value stored in the token storage unit 25, the random value confirmation and generation unit 242a returns true. Also, the random value that has been requested for confirmation does not match the random value stored in the token storage unit 25, the random value confirmation and generation unit 242a returns false.

The local server 22 returns a response to the browser execution unit 10 based on the check result from the token management unit 24a (S33a, S33b). Specifically, if the check result is true, the local server 22 returns the url (for example, “index.html”) of the Web application (the Web application 13 in the example in FIG. 4) (S33a). Thereby, the browser execution unit 10 is allowed to execute the Web application in the inline frame.

Also, if the check result is false, the local server 22 returns an error (S33b). That is to say, the local server 22 returns an error to a request that has been sent from a unit other than the browser execution unit 10, which is not aware of the random value sent from the start notification unit 23 together with the start notification. Accordingly, obtaining the Web application by an unpredictable request from the process P2, or the like is avoided.

Variation 2

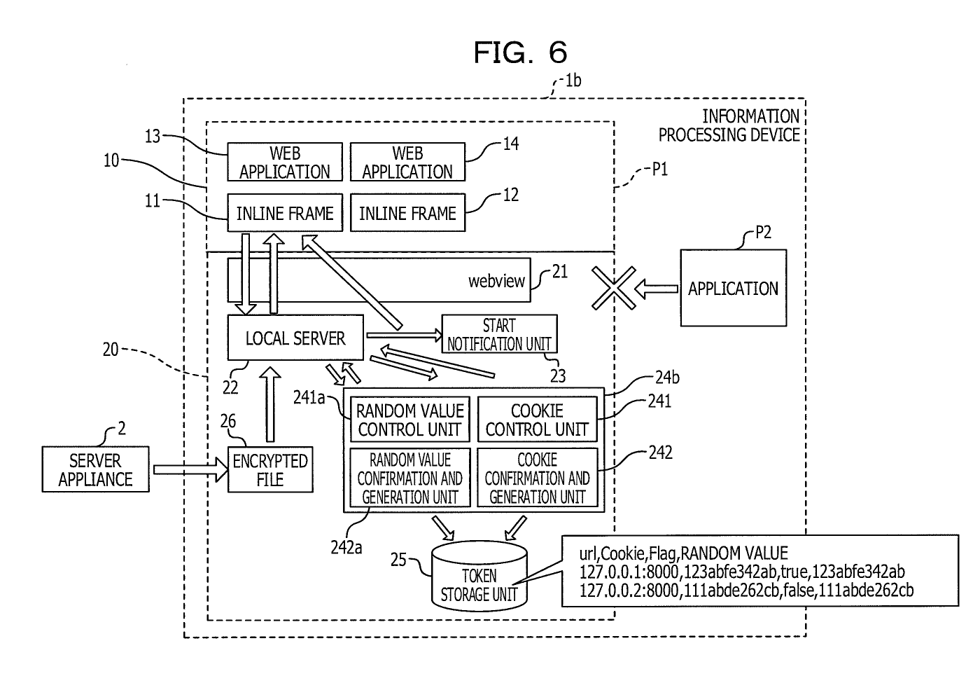

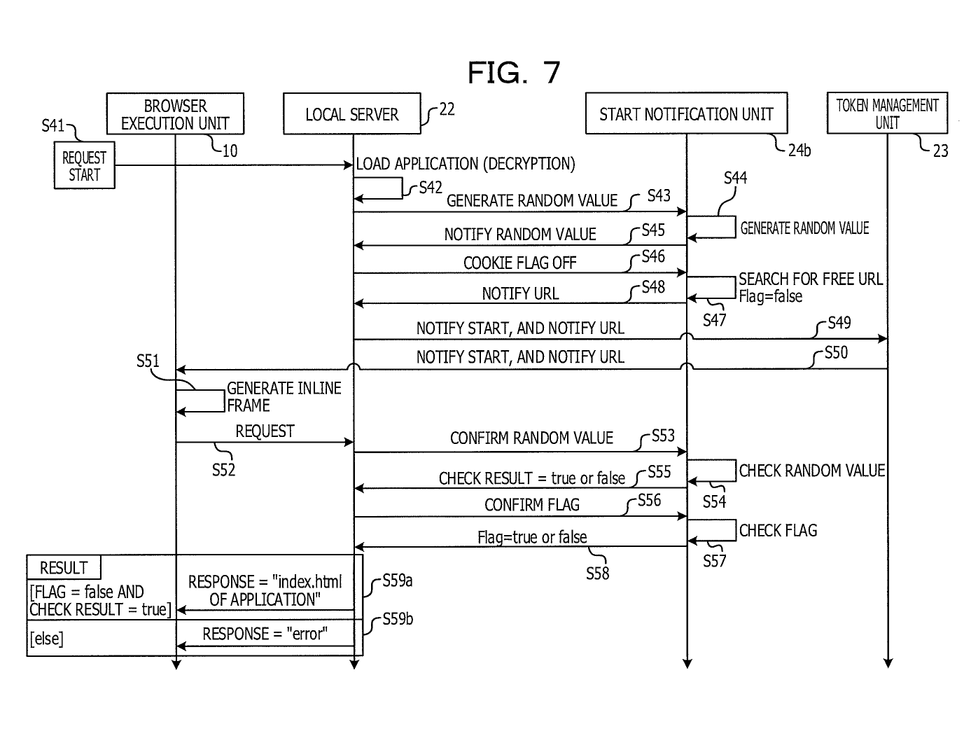

Next, a description will be given of the case of using a cookie and a random value generated randomly as token information related to the communication with the local server 22 as a variation 2 of the above-described embodiment. FIG. 6 is a block diagram exemplifying a functional configuration of an information processing device 1b according to a variation 2. FIG. 7 is a sequence diagram exemplifying operation of the information processing device lb according to the variation 2.

As illustrated in FIG. 6, the information processing device lb has a configuration including a token management unit 24b that manages a cookie and a random value as token information. The token management unit 24b includes a cookie control unit 241, a random value control unit 241a, a cookie confirmation and generation unit 242, and a random value confirmation and generation unit 242a.

As illustrated in FIG. 7, upon receiving a start request of the Web application (S41), the information processing device lb starts a process P1. The local server 22 loads the Web application (the Web application 13 in the example in FIG. 6) into the memory in response to the start request of the Web application (S42). Specifically, the local server 22 loads the Web application 13 produced by decrypting an encrypted file 26 into the memory.

Next, the local server 22 requests the token management unit 24b to generate a random value (S43). Upon receiving the request from the local server 22, the random value confirmation and generation unit 242a of the token management unit 24b generates a random value (S44). Specifically, the random value confirmation and generation unit 242a refers to the information stored in the token storage unit 25, and searches for an unused free url. Next, the random value confirmation and generation unit 242a generates a random value for the searched free url, and sets the url and the random value in the token storage unit 25. Next, the random value control unit 241a of the token management unit 24b notifies the random value to the local server 22 (S45).

Next, the local server 22 requests the token management unit 24b to generate a cookie with the flag off (Flag =false) (S46). Upon receiving the request from the local server 22, the cookie confirmation and generation unit 242 of the token management unit 24b generates a cookie (S47). Specifically, the cookie confirmation and generation unit 242 generates a cookie in the url in which the random value is set in S44, sets the cookie and the value of Flag as Flag=false in the token storage unit 25. Next, the cookie control unit 241 of the token management unit 24b notifies the url for which the cookie has been generated to the local server 22 (S48). In this regard, the generation and the notification of the random value, and the generation of the cookie and the notification of the url may be performed in the reverse order.

The local server 22 that has received the notification of the random value and the url notifies the start notification unit 23 of a start notification for starting the browser, and the url+random value (S49). The start notification unit 23 that has received the start notification, and the notification of url+random value from the local server 22 notifies the browser execution unit 10 of the start notification, and the url+random value to start the browser (S50).

The browser execution unit 10 that has received the start notification and the notification of url+random value generates an inline frame (the inline frame 11 in the example in FIG. 6) (S51), and requests the notified url+random value from the local server 22 (S52).

The local server 22 that has received the request for url+random value from the browser execution unit 10 requests the token management unit 24b to confirm the random value (S53). The random value confirmation and generation unit 242a of the token management unit 24b that has received the confirmation of the random value checks the random value of the url stored in the token storage unit 25 (S54), and returns the check result (true or false) (S55).

Next, the local server 22 requests the token management unit 24b to confirm the Flag of the url (S56). The cookie confirmation and generation unit 242 of the token management unit 24b that has received confirmation of the Flag of the url checks the Flag of the url stored in the token storage unit 25 (S57), and returns the check flag (true or false) (S58). In this regard, the confirmation of the random value, and the confirmation of the random value may be performed in the reverse order.

The local server 22 returns a response to the browser execution unit 10 based on the check result from the token management unit 24b (S59a, S59b). Specifically, if the check flag is false, and the check result is true, the local server 22 returns the url of the Web application (the Web application 13 in the example in FIG. 6) with a cookie (S59a). Thereby, the browser execution unit 10 is allowed to execute the Web application in the inline frame. Also, the browser execution unit 10 is allowed to securely perform communication with the local server 22 from that point in time through authentication by the cookie.

Also, in the case other than the case where both the check flag is false, and the check result is true, the local server 22 returns an error (S59b). That is to say, the local server 22 returns an error to a request that has been sent from a unit other than the browser execution unit 10, which is not aware of the random value sent from the start notification unit 23 together with the start notification, or a request after the Web application has been once returned. Accordingly, obtaining the Web application by an unpredictable request from the process P2, or the like is avoided.

All of or any one of the various processing functions executed on the information processing devices 1, 1a, and 1b, and the server appliance 2 may be performed by a CPU (or a micro computer, such as an MPU, a micro controller unit (MCU) and the like). Also, all of or any one of the various processing functions may be performed by a program analyzed and executed by a program on a CPU (or a micro computer, such as an MPU, an MCU, and the like) or by hardware of a wired logic, as a matter of course.

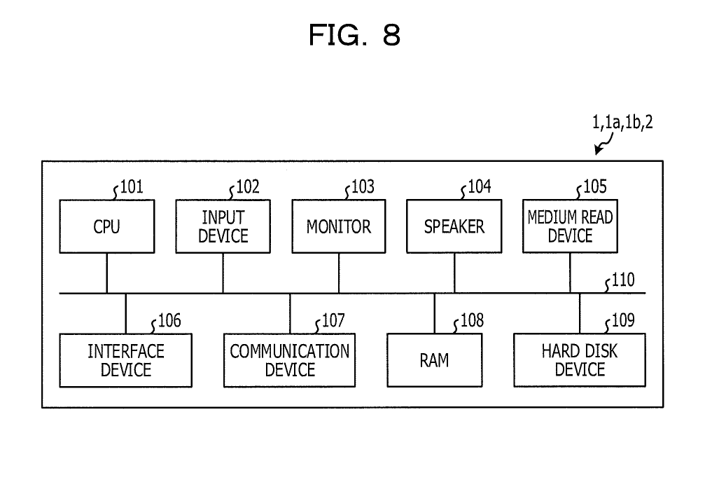

Incidentally, it is possible to achieve the various kinds of processing described in the above-described embodiment by executing a program provided in advance on a computer. Thus, in the following, a description will be given of an example of a computer (hardware) having the same function as the embodiments described above. FIG. 8 is a block diagram exemplifying a hardware configuration of the information processing devices 1, 1a, and 1b, and the server appliance 2.

As illustrated in FIG. 8, the information processing devices 1, 1a, and 1b, and the server appliance 2 include a CPU 101, which executes various kinds of arithmetic processing, an input device 102, which receives input data, a monitor 103, and a speaker 104. Also, the information processing devices 1, 1a, and 1b, and the server appliance 2 include a medium read device 105, which reads a program, and the like from a storage medium, an interface device 106 for connecting with various devices, and a communication device 107 for enabling communication with an external device through a wired or a wireless connection. Also, the information processing devices 1, 1a, and 1b, and the server appliance 2 include a RAM 108 for temporarily storing various kinds of information, and a hard disk device 109. Also, the individual units (101 to 109) of the information processing devices 1, 1a, and 1b, and the server appliance 2 are connected to a bus 110.

The hard disk device 109 stores programs having the same functions as the individual processing units of the browser execution unit 10 and the native function unit 20. Also, the hard disk device 109 stores various kinds of data for achieving the programs. The input device 102 receives operation information from an operator of the information processing devices 1, 1a, and 1b, and the server appliance 2, for example. The monitor 103 displays various screens operated by the operation, for example. A printer, or the like is connected to the interface device 106, for example. The communication device 107 is connected to a communication network, such as a local area network (LAN), or the like, and exchanges various kinds of information with external devices through a communication network. The CPU 101 reads each of the programs stored in the hard disk device 109, expands the programs on the RAM 108 so as to perform various kinds of processing.

In this regard, the above-described programs does not have to be stored in the hard disk device 109. For example, the programs that are stored in a storage medium in a readable manner by the information processing devices 1, 1a, and 1b, and the server appliance 2 may be read and executed by the information processing devices 1, 1a, and 1b, and the server appliance 2. The storage medium readable by the information processing devices 1, 1a, and 1b, and the server appliance 2, corresponds to for example, a portable recording medium, such as a CD-ROM, a DVD disc, a universal serial bus (USB) memory, and the like, a semiconductor memory, such as a flash memory, and the like, a hard disk drive, and the like. Also, the programs may be stored in devices connected to a public network, the Internet, a LAN, and the like, and the information processing devices 1, 1a, and 1b, and the server appliance 2 may read the programs from these devices to execute the programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a computer processor; and
a memory which stores a plurality of instructions, which when executed by the computer processor, cause the computer processor to execute:
obtaining a decrypted Web application from a Web server in a native area, and executing the decrypted Web application, giving a notification of obtaining the Web application to the computer processor based on the decryption of the Web application; and
obtaining the decrypted Web application from the Web server based on the notification.

2. The information processing device according to claim 1,
wherein if there is a request from the computer processor in a predetermined time period after the Web server gave the notification of obtaining the Web application, the Web server is configured to output the decrypted Web application to the computer processor.

3. The information processing device according to claim 1, further comprising:
managing token information of communication between the computer processor and the Web server,
wherein the giving a notification is giving the token information, and the notification of obtaining the Web application,
wherein if there is a request corresponding to the token information from the computer processor, the Web server outputting the decrypted Web application to the computer processor.

4. The information processing device according to claim 3,
wherein the token information is at least one of a cookie, a randomly-generated value, and a randomly-generated uniform resource locator (URL).

5. A method of processing information, comprising:
obtaining, by a computer processor, a decrypted Web application from a Web server in a native area, and executing the decrypted Web application, giving a notification of obtaining the Web application to the computer processor based on the decryption of the Web application; and
obtaining, by the computer processor, the decrypted Web application from the Web server based on the notification.

6. The method of processing information according to claim 5,
wherein if there is a request from the computer processor in a predetermined time period after the Web server gave the notification of obtaining the Web application, the Web server is configured to output the decrypted Web application to the computer processor.

7. The method of processing information according to claim 5, further comprising:
managing token information of communication between the computer processor and the Web server,
wherein the giving a notification is giving the token information, and the notification of obtaining the Web application,
wherein if there is a request corresponding to the token information from the computer processor, the Web server outputting the decrypted Web application to the computer processor.

8. The method of processing information according to claim 7,
wherein the token information is at least one of a cookie, a randomly-generated value, and a randomly-generated uniform resource locator (URL).

9. An information processing device comprising:
a computer processor configured to execute a native application which controlled by an operating system;
a memory configured to store the native application and a web application, which when executed by the computer processor, cause the computer processor to execute:
decrypting an encrypted file pertinent to the web application;
notifying the web application of authentication information and a receipt of a decrypted file by the decrypting pertinent to the web application;
having the web application inquire the decrypted file with the authentication information

10. An information processing system comprising:
a server appliance configured to distribute an encrypted Web application; and
an information processing device comprising:
a computer processor; and
a memory which stores a plurality of instructions, which when executed by the computer processor, cause the computer processor to execute:
obtaining, by a computer processor, the decrypted Web application from a Web server in a native area, and executing the decrypted Web application, giving a notification of obtaining the Web application to the computer processor based on the decryption of the Web application; and
obtaining the decrypted Web application from the Web server based on the notification.
